(19) United States
(12) Patent Application Publication
(10) Pub. No.: US 2002/0038523 A1
(43) Pub. Date: Apr. 4, 2002

(54) Method and article for promoting a message

(76) Inventor: Jean Anne Gibbens, Guelph (CA)

Correspondence Address: BORDEN LADNER GERVAIS, LLP, 1000 - 60 QUEEN STREET, OTTAWA, ON, K1P 5Y7, CA

(21) Appl. No.: 09/875,185

(22) Filed: Jun. 7, 2001

Related U.S. Application Data
(60) Provisional application No. 60/237,132, filed on Oct. 3, 2000.

(51) Int. Cl. G09F 21/02

(52) U.S. Cl. 40/586

(57) ABSTRACT

A method and an article for promoting a message, the method comprising the step of providing an article having an indicia applied on an outer surface of the article, at least a portion of the indicia being mirror inverted, whereby a person viewing the indicia image, as it is reflected via a mirror, is able to read and recognize the indicia in its readable orientation and to thereby receive a visual stimulus.

### REFERENCE TO RELATED APPLICATION

This is a formal application based on and claiming the benefit of provisional application ser. No. 60/237,132, filed Oct. 3, 2000.

### BACKGROUND OF THE INVENTION

1. Field of the Invention

This invention relates to an article, such as a piece of clothing or garment, for example a shirt, having a message displayed.

2. Description of the Prior Art

Several approaches have been adopted dealing with messages applied to pieces of clothing. Generally, these approaches deal with messages to be read or viewed by other persons than the wearer of the actual garment, for example a shirt.

U.S. Pat. No. 4,991,233 shows a shirt having a two-part message, one open part and one part hidden behind a flap. A person other than the wearer of the shirt is intended to read the first open part of the message and subsequently open the flap to read the hidden part of the message.

U.S. Pat. No. 4,999,848 shows a shirt having a two-part message, one open part and one part hidden behind a flap. The shirt is intended to be used in a similar way as the one described above, but with the difference that the hidden message is intended to cover the original open message when the flap is open.

U.S. Pat. No. 5,481,758 shows a T-shirt having a message and a “3D” lead-in to attract the attention of a person other than the wearer of the shirt.

U.S. Pat. No. 6,176,520 shows a method and an article for personalizing the promotion of an institution/organization/individual by including attributes in the displayed message, which are configured to evoke strong feelings of loyalty and allegiance from a user of the article (such as a shirt, for instance, having a message displayed on it).

All these garments share the common trait that the message carried on the garment is directed to persons other than the wearer him/her-self.

### SUMMARY OF THE INVENTION

A general object of the invention is to provide a method and an article for displaying a message to the user of an article in such a way that the message is readable only when viewing the mirror image of the message. The article is preferably a piece of clothing, for example a shirt, jacket, cap or trousers, or alternatively the article is a sign attached to the user or held by the user.

The message is made up of either text or non-text symbols, or combinations of both. For example, a known logo can be combined with a text message to be associated with the logo, which preferably stands for a product or a service that is known to the user or other viewers of the mirror image message.

Further objects of the invention is to provide a method and an article for displaying a message to the user of an article, or other viewers of the mirror image message, to enhance either the psychological well-being, influence the purchasing behavior, generally alter the mood or otherwise interact with the user or other viewers of the mirror message.

A method for promoting a message according to the invention, comprises the step of: providing an article having an indicia applied on an outer surface of the article, at least a portion of the indicia being mirror inverted, whereby a person viewing the indicia image, as it is reflected via a mirror is able to read and recognize the indicia in its readable orientation and to thereby receive a visual stimulus.

The visual stimulus is either a pleasant stimulus, which enhances the well-being of the person, an advertising stimulus, which influences the purchasing behavior of the person, a negative stimulus, which detracts from the well-being of the person, or a stimulus which alters the mood of the person.

The method advantageously comprises the further step of the person reading the indicia a plurality of times to thereby reinforce the received visible stimulus.

Preferably, the method comprises the further step of the person speaking an expression of the indicia to thereby receive an audible stimulus.

More preferably, the method comprises the further step of the person speaking an expression of the indicia a plurality of times to thereby reinforce the received audible stimulus.

The method advantageously comprises the further step of the person receiving tactile stimulus by touching the article and knowing the message of the indicia.

The article is preferably a garment having an indicia applied on an outer surface of the garment. The garment is either a shirt, a jacket, a hat, a cap, a pair of trousers or other pieces of clothing.

Alternatively, the article is a sign being held by the person.

At least a portion of the indicia advantageously has a mirror inverted textual expression.

An article for use in promoting a message according to the invention comprises an indicia applied on an outer surface of the article, at least a portion of the indicia being mirror inverted, for viewing by a person as the indicia is reflected via a mirror surface, allowing the person to read and recognize the indicia in its readable orientation and thereby receive a stimulus.

The visual stimulus is either a pleasant stimulus, which enhances the well-being of the person, an advertising stimulus, which influences the purchasing behavior of the person, a negative stimulus, which detracts from the well-being of the person, or a stimulus, which alters the mood of the person.

Advantageously, at least a portion of the indicia has a mirror inverted textual expression, for viewing by the person as the indicia is reflected via the mirror surface, to enable the person to read the textual expression in its readable orientation and thereby receive an inspirational stimulus.

The article is preferably a garment, for example a shirt, a jacket, a hat, a cap, or a pair of trousers.

Alternatively, the article is a sign being held by the person.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a sign according to a first embodiment of the invention, having an indicia with the message “STOP” as a mirrored image,

FIG. 2 is a garment according to a second embodiment of the invention, having an indicia with the textual message “WATER” as a mirrored image,

FIG. 3 is a garment according to a third embodiment of the invention, having an indicia with the textual message “CLEAN AIR” as a mirrored image,

FIG. 4 is a garment according to a fourth embodiment of the invention, having an indicia with the textual message “LIVE LIFE LOUD” as a mirrored image, and

FIG. 5 is a garment according to a fifth embodiment of the invention, having an indicia with the textual message “LIVE LONG” as a mirrored image.

### DETAILED DESCRIPTION OF THE PREFERRED EMBODIMENT

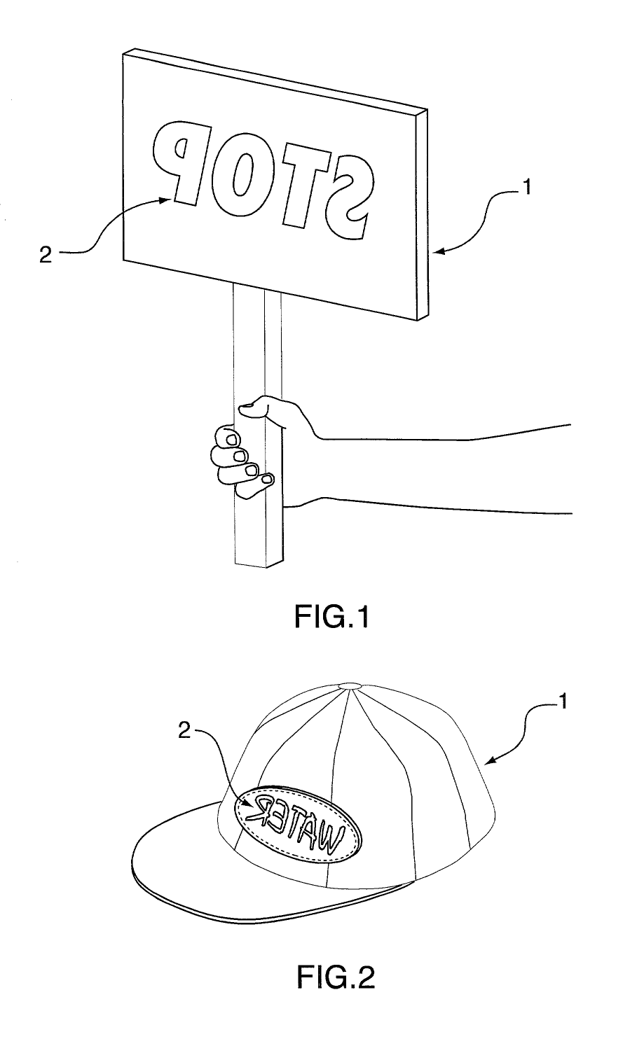

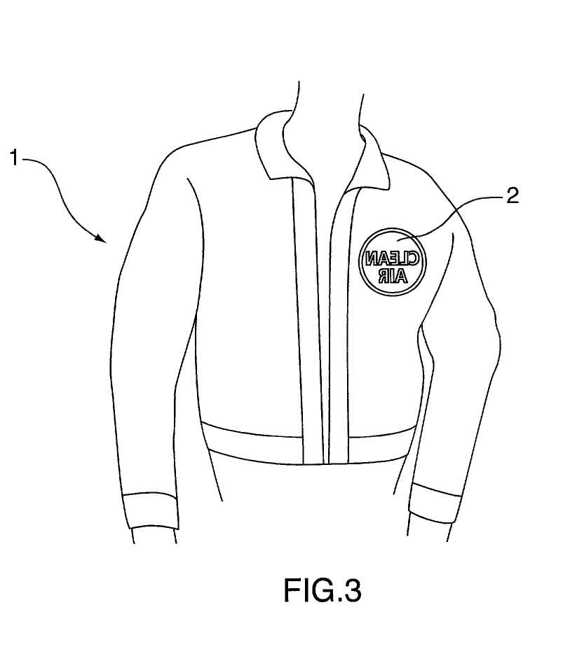

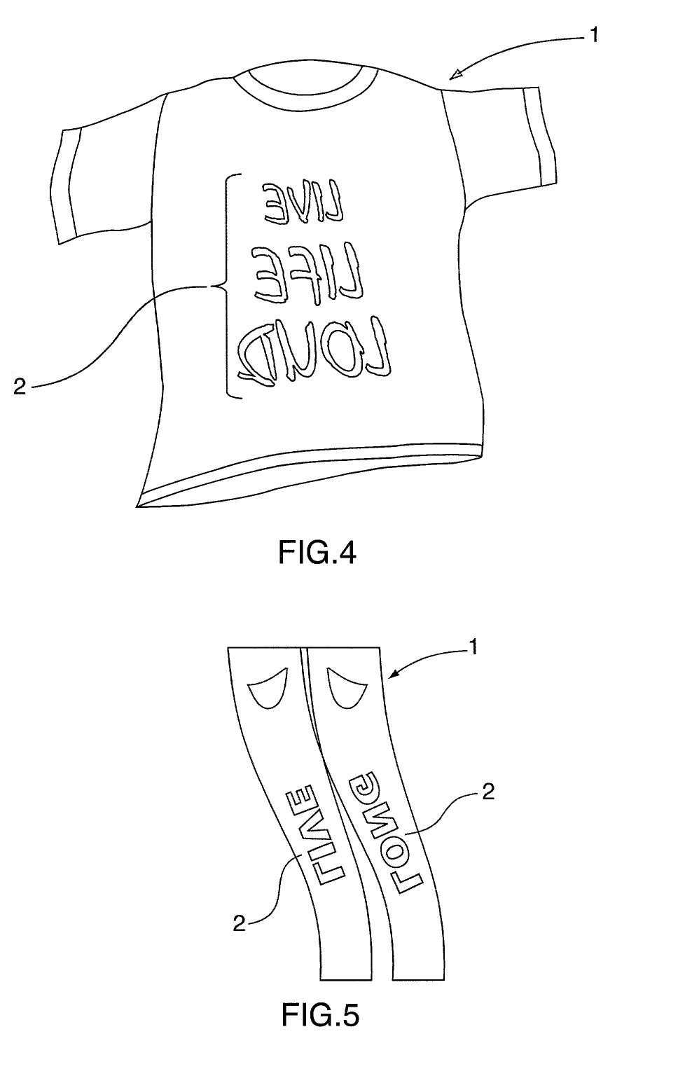

An article 1 according to the invention displays a message 2 to the user of an article in such a way that the message is readable only when viewing the mirror image of the message. The article is preferably a piece of clothing, for example a shirt, jacket, cap or trousers, or alternatively the article is a sign attached to the user or held by the user. FIG. 1 shows an embodiment of a sign according to the invention, displaying the word “STOP” as a mirrored image. FIG. 2 shows an embodiment of a cap according to the invention, displaying the word “WATER” as a mirrored image. FIG. 3 shows an embodiment of a jacket according to the invention, displaying an indicia having the words “CLEAN AIR” as a mirrored image. FIG. 4 shows an embodiment of a shirt according to the invention, displaying the words “LIVE LIFE LOUD” as a mirrored image. FIG. 5 shows an embodiment of a pair of trousers according to the invention, displaying the words “LIVE LONG” as a mirrored image. Advantageous alternative message carrying articles include pins and buttons, decals and stickers, and tattoos, permanent or non-permanent.

Generally, the message 2 is made up of indicia which may be either text or non-text symbols, or combinations of both. For example, a known logo can be combined with a text message to be associated with the logo. The logo should then preferably stand for a product or a service that is known to the user or other viewers of the mirror image message.

When displaying the message to the user of an article, or other viewers of the mirror image message, the aim is to enhance either the psychological well-being, influence the purchasing behavior, generally alter the mood or otherwise interact with the user or other viewers of the mirror message.

It will be appreciated that the above description relates to the preferred embodiments by way of example only. Many variations on the invention will be obvious to those knowledgeable in the field, and such obvious variations are within the scope of the invention as described and claimed, whether or not expressly described.

What is claimed as the invention is:

1. A method for promoting a message, comprising the step of:
providing an article having an indicia applied on an outer surface of said article, at least a portion of said indicia being mirror inverted, whereby a person viewing said indicia image, as it is reflected via a mirror, is able to read and recognize said indicia in its readable orientation and to thereby receive a visual stimulus.

2. The method as recited in claim 1, wherein said visual stimulus is a pleasant stimulus, which enhances the well-being of the person.

3. The method as recited in claim 1, wherein said visual stimulus is an advertising stimulus, which influences the purchasing behavior of the person.

4. The method as recited in claim 1, wherein said visual stimulus is a negative stimulus, which detracts from the well-being of the person.

5. The method as recited in claim 1, wherein said visual stimulus is a stimulus, which alters the mood of the person.

6. The method as recited in claim 1, wherein said method comprises the further step of the person reading said indicia a plurality of times to thereby reinforce the received visible stimulus.

7. The method as recited in claim 1, wherein said method comprises the further step of the person speaking an expression of said indicia to thereby receive an audible stimulus.

8. The method as recited in claim 7, wherein said method comprises the further step of the person speaking an expression of said indicia a plurality of times to thereby reinforce the received audible stimulus.

9. The method as recited in claim 1, wherein said method comprises the further step of the person receiving tactile stimulus by touching said article and knowing the message of said indicia.

10. The method as recited in claim 1, wherein said article is a garment having an indicia applied on an outer surface of said garment.

11. The method as recited in claim 10, wherein said garment is a shirt.

12. The method as recited in claim 10, wherein said garment is a jacket.

13. The method as recited in claim 10, wherein said garment is a hat.

14. The article as recited in claim 10, wherein said garment is a pair of trousers.

15. The article as recited in claim 1, wherein said article is a sign being held by the person.

16. The method as recited in claim 1, wherein at least a portion of said indicia has a mirror inverted textual expression.

17. An article for use in promoting a message, comprising:
an indicia applied on an outer surface of said article, at least a portion of said indicia being mirror inverted, for viewing by a person as said indicia is reflected via a mirror surface, allowing the person to read and recognize said indicia in its readable orientation and thereby receive a stimulus.

18. The article as recited in claim 17, wherein said visual stimulus is a pleasant stimulus, which enhances the well-being of the person.

19. The article as recited in claim 17, wherein said visual stimulus is an advertising stimulus, which influences the purchasing behavior of the person.

20. The article as recited in claim 17, wherein said visual stimulus is a negative stimulus, which detracts from the well-being of the person.

21. The article as recited in claim 17, wherein said visual stimulus is a stimulus, which alters the mood of the person.

22. The article as recited in claim 17, wherein at least a portion of said indicia has a mirror inverted textual expression, for viewing by the person as said indicia is reflected via the mirror surface, to enable the person to read said textual expression in its readable orientation and thereby receive an inspirational stimulus.

23. The article as recited in claim 17, wherein said article is a garment.

24. The article as recited in claim 23, wherein said garment is a shirt.

25. The article as recited in claim 23, wherein said garment is a jacket.

26. The article as recited in claim 23, wherein said garment is a hat.

27. The article as recited in claim 23, wherein said garment is a pair of trousers.

28. The article as recited in claim 17, wherein said article is a sign being held by the person.
